(19) United States
(12) Patent Application Publication
(10) Pub. No.: US 2019/0034562 A1
(43) Pub. Date: Jan. 31, 2019

(54) HIGH-LEVEL SYNTHESIS DEVICE, HIGH-LEVEL SYNTHESIS METHOD, AND COMPUTER READABLE MEDIUM

(71) Applicant: Mitsubishi Electric Corporation, Tokyo (JP)

(72) Inventors: Yoshihiro OGAWA, Tokyo (JP); Fumitoshi KARUBE, Tokyo (JP); Ryo YAMAMOTO, Tokyo (JP)

(73) Assignee: Mitsubishi Electric Corporation, Tokyo (JP)

(21) Appl. No.: 16/073,204

(22) PCT Filed: Mar. 17, 2016
(86) PCT No.: PCT/JP2016/058445

§ 371 Date: Jul. 26, 2018

(51) Int. Cl. G06F 17/50; G06F 9/30; G06F 9/38

(52) U.S. Cl. CPC G06F 17/505; G06F 9/3001; G06F 15/7821; G06F 9/3885; G06F 17/5054

(57) ABSTRACT

The present invention is provided with a control data flow graph change unit to obtain, as a first CDFG, a CDFG representing a repeat arithmetic process to repeat an arithmetic process, the repeat arithmetic process using an output of the arithmetic process as an input to a next arithmetic process, and to change the first CDFG into a second CDFG to perform the repeat arithmetic process represented by the first CDFG through pipeline processing.

### TECHNICAL FIELD

The present invention relates to a high-level synthesis device, a high-level synthesis method, and a high-level synthesis program to automatically generate a register-transfer level hardware description language (HDL) from a behavioral description in a programming language.

### BACKGROUND ART

Conventionally, in the development of a large scale integration (LSI), design has been performed in a hardware description language, such as Verilog-HDL or VHDL. However, as integrated circuits have increased in size in recent years, design using a hardware description language lets the amount of design descriptions be enormous, and requires tremendous design time; hence, improvement in design productivity is sought. As one technique to improve design productivity, there is a high-level synthesis technique to automatically synthesize a register-transfer level circuit description from a behavioral description. The high-level synthesis technique is a technique to perform design in a high-level language, such as the C language, the C++ language or the System C language, with a higher level of abstraction than a hardware description language, and to automatically generate a hardware description language by using a high-level synthesis tool. By the high-level synthesis technique, it is possible to reduce the amount of design description, and to reduce the design time.

In a technique disclosed in Patent Literature 1, a behavioral-level description is separated into N stage descriptions, and a timing is adjusted in a scheduling unit so that pipeline processing of input/output and operations among the N stage descriptions are performed. Then, in the technique disclosed in Patent Literature 1, a hardware description language is generated so that stage circuits for each of the N stage descriptions, and a state control circuit to control possible 2N−1 stage states of a semiconductor integrated circuit are generated. In this manner, Patent Literature 1 discloses a behavioral synthesis method to realize a high-speed pipelined circuit.

### CITATION LIST

### Patent Literature

Patent Literature 1: JP 2010-086310 A

### SUMMARY OF INVENTION

### Technical Problem

There is a problem that the technique disclosed in Patent Literature 1 cannot be applied to a behavioral description of a circuit to perform a repeat arithmetic process to repeat an arithmetic process, wherein output of the arithmetic process is used as input to the next arithmetic process.

The present invention is aimed at providing a high-level synthesis device to generate a hardware description language with high processing performance, by enabling pipeline processing, even when a behavioral description of a circuit to perform a repeat arithmetic process to repeat an arithmetic process, wherein output of the arithmetic process is used as input to the next arithmetic process, is used as input.

### Solution to Problem

A high-level synthesis device according to one aspect of the present invention includes a control data flow graph (CDFG) change unit to obtain, as a first CDFG, a CDFG representing a repeat arithmetic process to repeat an arithmetic process, the repeat arithmetic process using an output of the arithmetic process as an input to a next arithmetic process, and to change the first CDFG into the second CDFG to perform the repeat arithmetic process represented by the first CDFG through pipeline processing.

### Advantageous Effects of Invention

A high-level synthesis device according to the present invention includes a control data flow graph (CDFG) change unit to obtain, as a first CDFG, a CDFG representing a repeat arithmetic process to repeat an arithmetic process, in which output of the arithmetic process is used as input to the next arithmetic process, and to change the repeat arithmetic process into the second CDFG to execute the repeat arithmetic process represented in the first CDFG through pipeline processing; hence, there is an effect that the repeat arithmetic process can be pipelined.

### BRIEF DESCRIPTION OF DRAWINGS

FIG. 1 is a configuration diagram of a high-level synthesis device 100 according to a first embodiment;

FIG. 2 is a configuration diagram of a high-level synthesis device 100x using a high-level synthesis technique;

FIG. 3 is a flowchart illustrating an operation of the high-level synthesis device 100x in FIG. 2;

FIG. 4 is a diagram illustrating a schematic example of a source code 171;

FIG. 5 is a diagram illustrating an example of an addition operation of floating points;

FIG. 6 is a timing chart in a case wherein processing of the addition operation of floating points illustrated in FIG. 4 is performed through pipeline processing;

FIG. 7 is a timing chart in a case wherein an execution timing of processing for each clock cycle is changed so as to avoid a data hazard in FIG. 6;

FIG. 8 is a flowchart illustrating a high-level synthesis process S100 by a high-level synthesis method 510 and a high-level synthesis program 520 of the high-level synthesis device 100 according to the first embodiment;

FIG. 9 is a diagram illustrating an example of a first CDFG 111 generated from the source code 171 illustrated in FIG. 4 by the CDFG generation unit 110 according to the first embodiment;

FIG. 10 is a diagram illustrating an example of a scheduling result 122 according to the first embodiment;

FIG. 11 is a flowchart of a pipeline judgment process S150 according to the first embodiment;

FIG. 12 is a diagram illustrating an example of a second CDFG 112 to which the first CDFG 111 is changed by the CDFG change unit 160 according to the first embodiment;

FIG. 13 is a flowchart of a CDFG change process S160 according to the first embodiment;

FIG. 14 is an example of an arithmetic process before and after the CDFG change process S160 according to the first embodiment, represented in a formula;

FIG. 15 is an example of the arithmetic process before and after the CDFG change process S160 according to the first embodiment, represented in a circuit; and

FIG. 16 is a configuration diagram of a high-level synthesis device 100y according to a variation of the first embodiment.

### DESCRIPTION OF EMBODIMENTS

### First Embodiment

### Explanation of Configuration

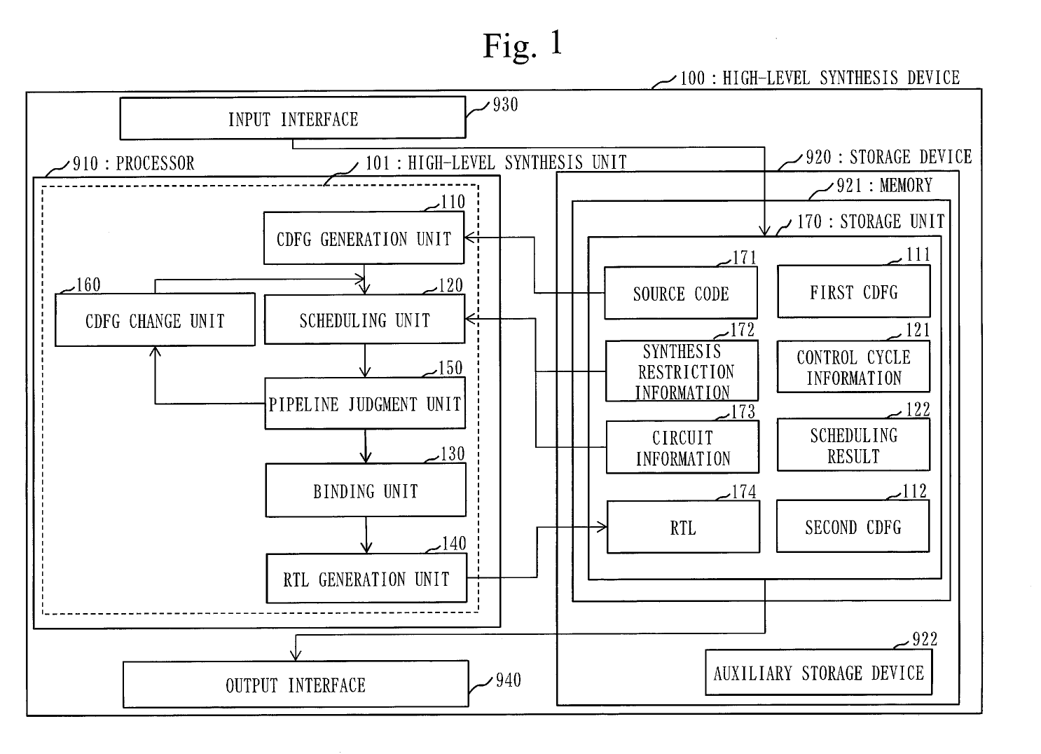

A configuration of a high-level synthesis device 100 according to the present embodiment will be discussed using FIG. 1.

In the present embodiment, the high-level synthesis device 100 is a computer. The high-level synthesis device 100 is equipped with hardware components such as a processor 910, a storage device 920, an input interface 930 and an output interface 940. The storage device 920 includes a memory 921 and an auxiliary storage device 922.

The high-level synthesis device 100 is equipped with, as a functional configuration, a CDFG generation unit 110, a scheduling unit 120, a pipeline judgment unit 150, a CDFG change unit 160, a binding unit 130, an RTL generation unit 140 and a storage unit 170.

In the following explanation, the CDFG generation unit 110, the scheduling unit 120, the pipeline judgment unit 150, the CDFG change unit 160, the binding unit 130 and the RTL generation unit 140 in the high-level synthesis device 100 are collectively called a high-level synthesis unit 101 as well. Further, in the following explanation, the functions of the CDFG generation unit 110, the scheduling unit 120, the pipeline judgment unit 150, the CDFG change unit 160, the binding unit 130 and the RTL generation unit 140 in the high-level synthesis device 100 are referred to as functions of “units” of the high-level synthesis device 100.

The functions of the “units” of the high-level synthesis device 100 are realized by software.

Further, the storage unit 170 is realized by the storage device 920. The storage unit 170 stores a source code 171, synthesis restriction information 172, circuit information 173 and RTL 174. Further, the storage unit 170 stores information such as the first CDFG 111 generated by the CDFG generation unit 110, control cycle information 121 and a scheduling result 122 generated by the scheduling unit 120, and the second CDFG 112 generated by the CDFG change unit 160.

The processor 910 is connected to other hardware components via a signal line to control the other hardware components.

The processor 910 is an integrated circuit (IC) to perform processing. The processor 910 is, as a specific example, a central processing unit (CPU).

The storage device 920 includes the memory 921 and the auxiliary storage device 922. The auxiliary storage device 922 is, as a specific example, a read only memory (ROM), a flash memory, or a hard disk drive (HDD). The memory 921 is, as a specific example, a random access memory (RAM). In the present embodiment, the storage unit 170 is realized by the memory 921. The storage unit 170 may be realized by the auxiliary storage device 922, or may be realized by the memory 921 and the auxiliary storage device 922. A realization method of the storage unit 170 is arbitrary.

The input interface 930 is a port whereto an input device such as a mouse, a keyboard, or a touch panel is connected. The input interface 930 is, as a specific example, a USB terminal. The input interface 930 may be a port whereto a local area network (LAN) is connected.

The output interface 940 is a port whereto a cable of a display apparatus such as a display device is connected. The output interface 940 is, as a specific example, a USB terminal or a high definition multimedia interface (HDMI) (registered trademark) terminal. The display device is, as a specific example, a liquid crystal display (LCD). The output interface 940 may be connected to an output device, such as a printer device.

The auxiliary storage device 922 stores a program to realize the functions of the “units.” The program is loaded into the memory 921, read into the processor 910, and executed by the processor 910. The auxiliary storage device 922 also stores an operating system (OS). At least a part of the OS is loaded into the memory 921, and the processor 910 executes the program to realize the functions of the “units” while executing the OS.

The high-level synthesis device 100 may be equipped with only one processor 910, or may be equipped with a plurality of processors 910. The plurality of processors 910 may cooperatively execute the program to realize the functions of the “units.”

The information, data, signal values and variable values indicating the results of the processing by the functions of “units” are stored in the memory 921, the auxiliary storage device 922, or a register or a cache memory in the processor 910. The arrows connecting each unit and the storage unit 170 in FIG. 1 represent that each unit makes the storage unit 170 store the results of processing, or that each unit reads out information from the storage unit 170. Further, the arrows connecting each unit represent flows of control.

The program to realize the functions of the “units” may be stored in a portable recording medium such as a magnetic disk, a flexible disk, an optical disc, a compact disk, a blue-ray (registered trademark) disc, a digital versatile disc (DVD), etc.

Note that the program to realize the functions of the “units” is also called a high-level synthesis program 520. The high-level synthesis program 520 is a program to realize the function described as the “units.” Further, what is called a high-level synthesis program product is a storage medium and a storage device wherein the high-level synthesis program 520 is recorded, into which a computer-readable program is loaded, irrespective of the form as it appears.

Next, a high-level synthesis technique as a premise of the present embodiment will be described.

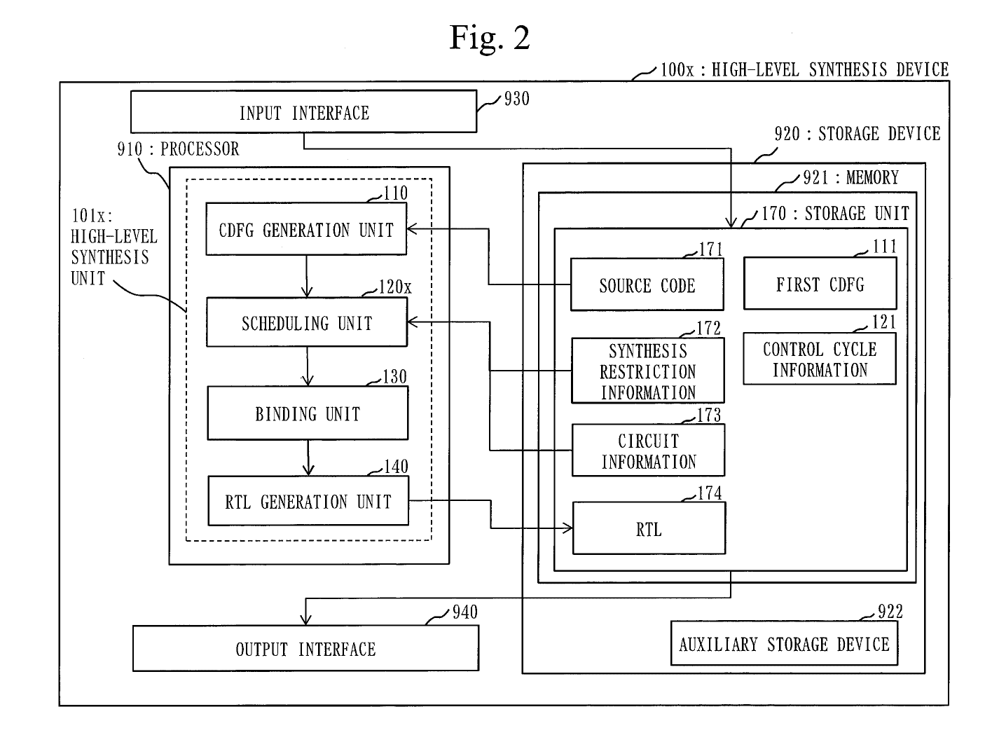

FIG. 2 is a diagram illustrating a configuration of a high-level synthesis device 100x using the high-level synthesis technique as the premise of the present embodiment.

The high-level synthesis device 100x is a configuration which is obtained by removing the pipeline judgment unit 150 and the CDFG change unit 160 from the configuration of the high-level synthesis device 100 according to the present embodiment described in FIG. 1. That is, the high-level synthesis unit 101x of the high-level synthesis device 100x is equipped with the CDFG generation unit 110, the scheduling unit 120x, the binding unit 130 and the RTL generation unit 140. Further, the storage unit 170 stores the first CDFG 111 and the control cycle information 121, but the storage unit 170 does not store the scheduling result 122 and the second CDFG 112.

The high-level synthesis unit 101x performs high-level synthesis by using the source code 171, the synthesis restriction information 172 and the circuit information 173 as input, and outputs the RTL 174.

The RTL 174 is an example of a hardware description language.

The source code 171 is a behavioral description describing operations of a circuit as a subject of high-level synthesis in a high-level language, such as the C language, the C++ language and the System C language. The source code 171 is input via the input interface 930 from the input device, and stored in the storage unit 170.

The synthesis restriction information 172 includes information such as a circuit size, resource amount, timing restriction, clock frequency, a unit to be pipelined of the circuit as the subject of high-level synthesis. The synthesis restriction information 172 is input via the input interface 930 from the input device, and stored in the storage unit 170.

The circuit information 173 includes information such as the size and delay information, etc. of an arithmetic unit, a register, a memory unit, etc. provided in an LSI whereon a circuit after high-level synthesis is mounted. The circuit information 173 is input via the input interface 930 from the input device, and stored in the storage unit 170.

The RTL 174 is a circuit description wherein a circuit structure is written in a hardware description language. The circuit description is what to describe a circuit behavior by a combination of flows of signals between registers, and logical operations.

The circuit description is also referred to as a structural description of a circuit.

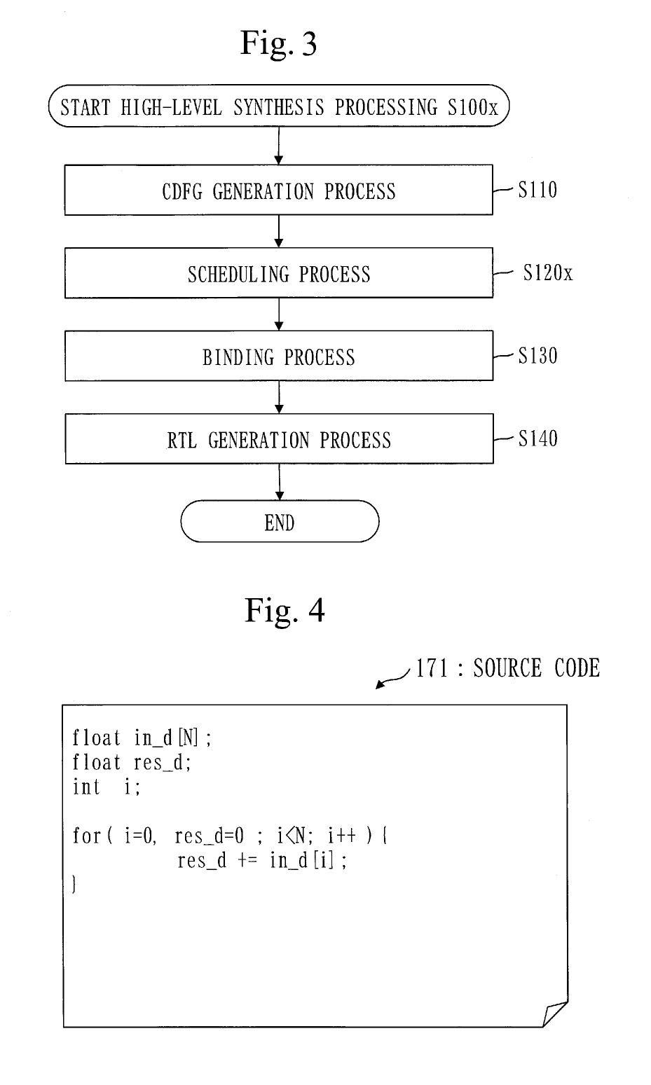

An outline of the high-level synthesis process S100x being the operation of the high-level synthesis device 100x in FIG. 2 will be described using FIG. 3. The high-level synthesis process S100x is processing using the high-level synthesis technique being the premise of the present embodiment. The high-level synthesis process S100x includes a CDFG generation process S110, a scheduling process S120x, a binding process S130 and an RTL generation process S140.

In the CDFG generation process S110, the CDFG generation unit 110 performs syntax analysis of the source code 171, analyzes control structure and data dependency, and generates a control data flow graph (CDFG) 111. The first CDFG 111 is a graph representing a control flow and a data flow. The data flow is represented by nodes indicating arithmetic operations, nodes indicating variables, and edges joining a node to another node. The CDFG generation unit 110 deletes a redundant operation node. Further, the CDFG generation unit 110 performs deletion of unnecessary processing, deletion of common part processing, processing of constant propagation and constant convolution, and processing of increasing parallelism by deploying loop processing, etc. in order to generate a structure description of a circuit improved at its performance and reduced at its area. The first CDFG 111 will be described below in detail.

Next, in the scheduling process S120x, the scheduling unit 120x determines a control cycle necessary for performing processing indicated by each node inside the first CDFG 111, and outputs the control cycle as control cycle information 121. The scheduling unit 120x determines the control cycle based on a clock frequency set in the synthesis restriction information 172, and delay information of an arithmetic unit, a register, a memory unit, etc. set in the circuit information 173. At this time, the scheduling unit 120x tries the control cycle wherein a repeat process included in the first CDFG 111 is pipelined. When the processing cannot be performed in the control cycle tried, the scheduling unit 120x tries another method, and determines a control cycle. The scheduling unit 120x outputs the control cycle information 121 including the control cycle as a scheduling result 122.

Next, in the binding process S130, the binding unit 130 assigns hardware resources such as a hardware storage resource, a hardware arithmetic resource, etc. to a circuit based on the control cycle information 121. The binding unit 130 analyzes the lifetime of the hardware resources from the control cycle information 121. Based on the analysis result, the binding unit 130 assigns the same hardware resource to a hardware resource whose lifetime does not overlap, among hardware resources capable of the same processing, and shares hardware. The binding unit 130 outputs the assignment result of the hardware resources to the circuit as a binding result.

Lastly, in the RTL generation process S140, the RTL generation unit 140 generates a control circuit to be necessary for realizing the control cycle information 121 and the binding result. Then, the RTL generation unit 140 outputs an RTL 174 being a register transfer level description in addition to a data path whereto the hardware resources obtained by the binding unit 130 are connected.

Next, the high-level synthesis technique being a premise of the present embodiment will be described using specific examples.

FIG. 4 is a diagram illustrating a specific example of the source code 171. In FIG. 4, a C language program describing a behavioral description to calculate a total value of a plurality of input values of floating points is illustrated as an example of the source code 171.

The source code 171 illustrated in FIG. 4 indicates an operation to store a total value of N-pieces of values stored in an array “in_d” of floating points to be input. In the source code 171 indicated in FIG. 4, ‘0’ is set to “res_d” in an initial state, and processing to add “in_d[i]” being an input value to “res_d” is repeated in each loop processing; hence the total value of the input values is calculated. In the source code 171 illustrated in FIG. 4, a loop count is N.

The source code 171 illustrated in FIG. 4 includes a repeat process to repeat operations by letting an output variable be the next input variable. In order to generate an RTL description with high processing performance, i.e., the product of processing latency and a clock cycle, from the source code 171 including the repeat process, it is necessary to make the repeat process be performed through pipeline processing, and to enhance the throughput performance of the repeat process.

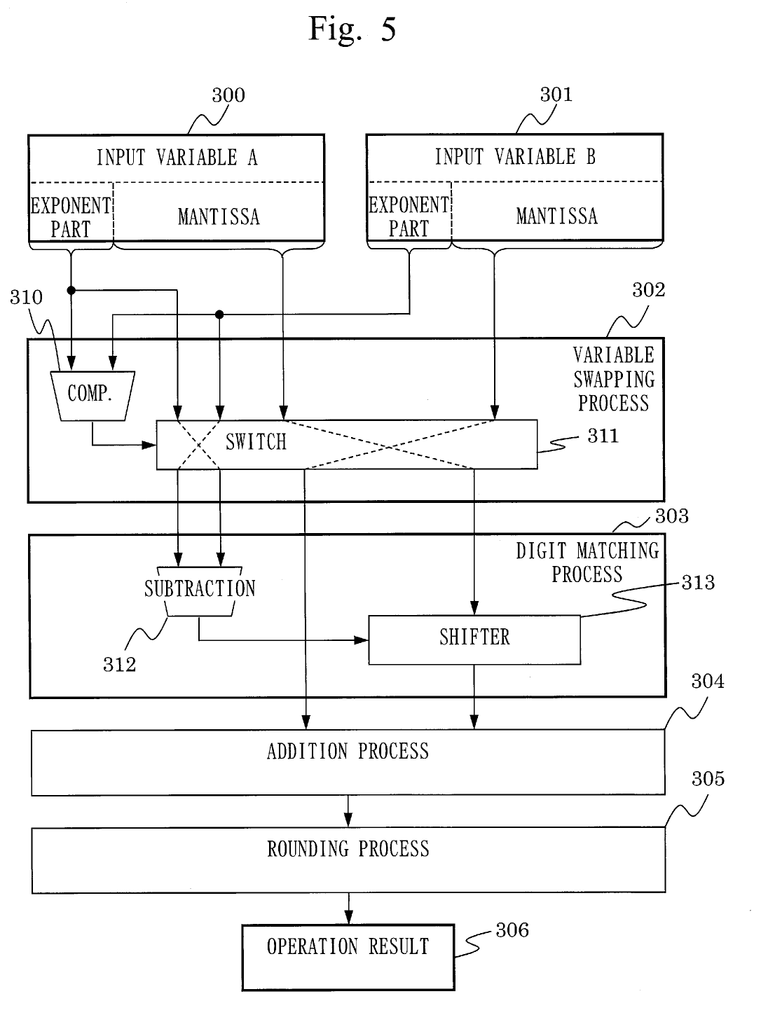

FIG. 5 illustrates an example of a summation operation of floating points.

As illustrated in FIG. 5, the summation operation of the floating points is to perform a variable swapping process 302, a digit matching process 303, an addition process 304 and a rounding process 305 on an input variable A300 and an input variable B301, and to obtain an operation result 306.

In the variable swapping process 302, an exponent part of the input variable A300 and an exponent part of the input variable B301 are compared in magnitude by a comparison 310, and a variable being a subject of processing of the digit matching process 303 is selected by a switch 311. In this case, when the exponent part of the input variable B301 is larger than the exponent part of the input variable A300, the mantissa of the input variable A300 is passed to the digit matching process 303 as a subject of the digit matching process, and the mantissa of the input variable B301 is passed to the digit matching process 303 as being unnecessary to be performed the digit matching process. When the exponent part of the input variable B301 is smaller than the exponent part of the input variable A300, the mantissa of the input variable B301 is passed to the digit matching process 303 as a subject of the digit matching process, and the mantissa of the input variable A300 is passed to the digit matching process 303 as being unnecessary to be performed the digit matching process.

In the digit matching process 303, the mantissa of the variable passed from the variable swapping process 302 as the subject of the digit matching process 303 in the variable swapping process 302 is performed a shift process to the right by a shifter 313, and is performed digit matching with the mantissa of the variable passed from the variable swapping process 302 as being unnecessary to be matched digits. The variable which has been performed digit matching is passed to the addition process 304. The shift amount for digit matching is calculated from a difference between the exponent part of the input variable A300 and the exponent part of the input variable B301 by subtraction 312.

Further, for the mantissa of the variable passed from the variable swapping process 302 as a variable unnecessary to be performed the digit matching process, the value input is passed as it is to the addition process 304.

In the addition process 304, the sum of two variables whose digits have been matched, which have been passed from the digit matching process 303, is obtained, and is output to the rounding process 305. Note that when the signs of two variables of the input variable A300 and the input value B301 are the same, addition is performed; meanwhile when the signs are different, subtraction is performed.

In the rounding process 305, a rounding process of the addition result passed from the addition process 304 to an approximate value is performed in order to normalize the addition result in accordance with the standard of IEEE 754, etc., which is then output as an operation result 306.

When the total value of the floating points as illustrated in FIG. 4 is calculated, the value of the array “in_d” in FIG. 4 is input into the input variable A300 in the array order, and the value of “res_d” in FIG. 4 is input into the input variable B301. That is, the operation result 306 in FIG. 5 becomes input into the input variable B301.

As described above, for the addition operation of the floating points, many processing steps are necessary, and longer calculation time is necessary than addition of integers. When the series of processing steps is performed by one clock, the clock rate becomes extremely low; hence generally, a circuit is designed in such a manner that each processing step is performed in different clock cycles.

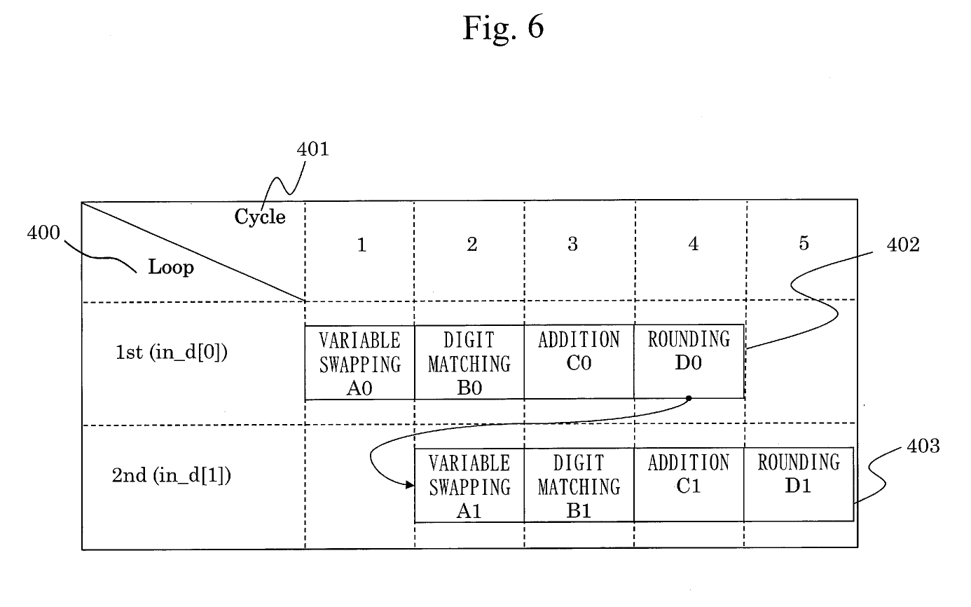

FIG. 6 is an example of a timing diagram in a case wherein the processing of an addition operation of floating points illustrated in FIG. 4 is performed through pipeline processing.

A loop 400 indicates a loop count in the repeat process illustrated in FIG. 4. A cycle 401 indicates a clock cycle. Processing 402 indicates processing for each clock cycle in the first loop. Processing 403 indicates processing for each clock cycle in the second loop. In FIG. 4, the loop count is N.

In the processing for each clock cycle of the processing 402 and the processing 403, variable swapping A0 and variable swapping A1 in FIG. 6 correspond to the variable swapping process 302 in FIG. 5. Digit matching BO and digit matching B1 in FIG. 6 correspond to the digit matching process 303 in FIG. 5. Addition C0 and addition C1 in FIG. 6 correspond to the addition process 304 in FIG. 5. Rounding D0 and rounding D1 in FIG. 6 correspond to the rounding process 305 in FIG. 5.

The processing cycles of the arithmetic process in one loop is four cycles in FIG. 6; meanwhile, by letting the arithmetic process be performed through pipeline processing, the arithmetic process can be performed in “N+3” cycles in the number of processing cycles of total value calculation from N-piece floating points array.

However, in FIG. 6, while the rounding DO of the processing 402 is performed in the fourth cycle, the variable swapping Al of the processing 403 is performed in the second cycle. Since there is data dependence between iterations between output data of the rounding DO of the processing 402, and input data of the variable swapping Al of the processing 403, there is concern that a data hazard may occur, and a desired operation result cannot be obtained.

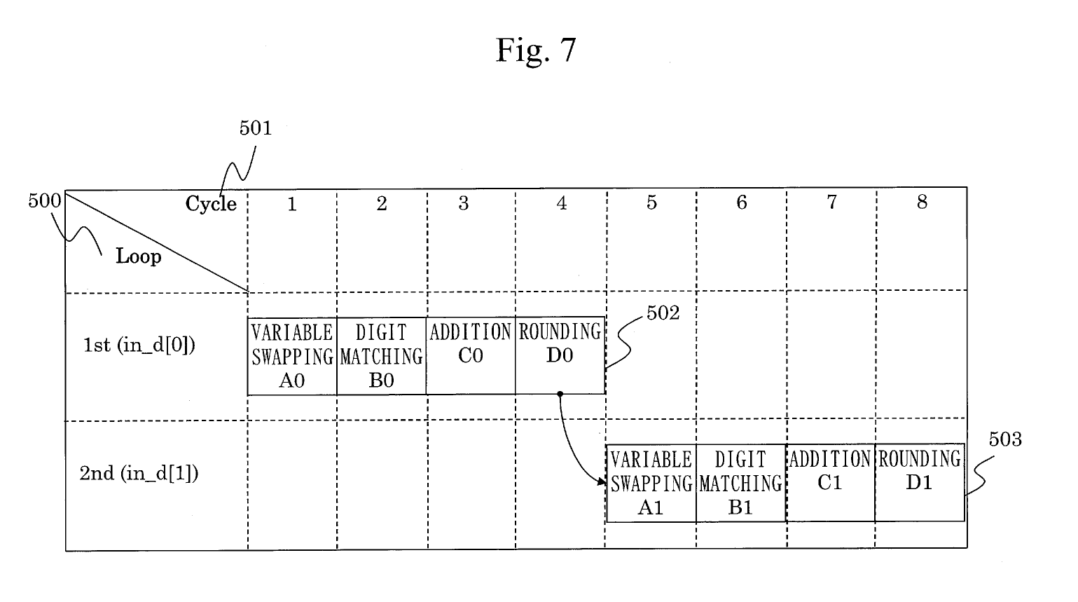

FIG. 7 is an example of a timing chart in a case wherein an execution timing of processing for each clock cycle is changed so as to avoid a data hazard as against FIG. 6.

In FIG. 7, a loop 500 corresponds to the loop 400 in FIG. 6, and a cycle 501 corresponds to the cycle 401 in FIG. 6. Further, processing 502 corresponds to the processing 402 in FIG. 6, and processing 503 corresponds to the processing 403 in FIG. 6.

In FIG. 7, a data hazard is avoided by changing variable swapping A1 of the processing 503 so as to be performed in the fifth cycle after performing rounding D0 of the processing 502 in the fourth cycle.

However, in FIG. 7, “N*4” cycles are necessary as the number of processing cycles of total value calculation from N-piece floating points array.

This concludes the explanation of the high-level synthesis technique being the premise of the present embodiment.

### Explanation of Operation

Next, an operation of the high-level synthesis device 100 according to the present embodiment will be described.

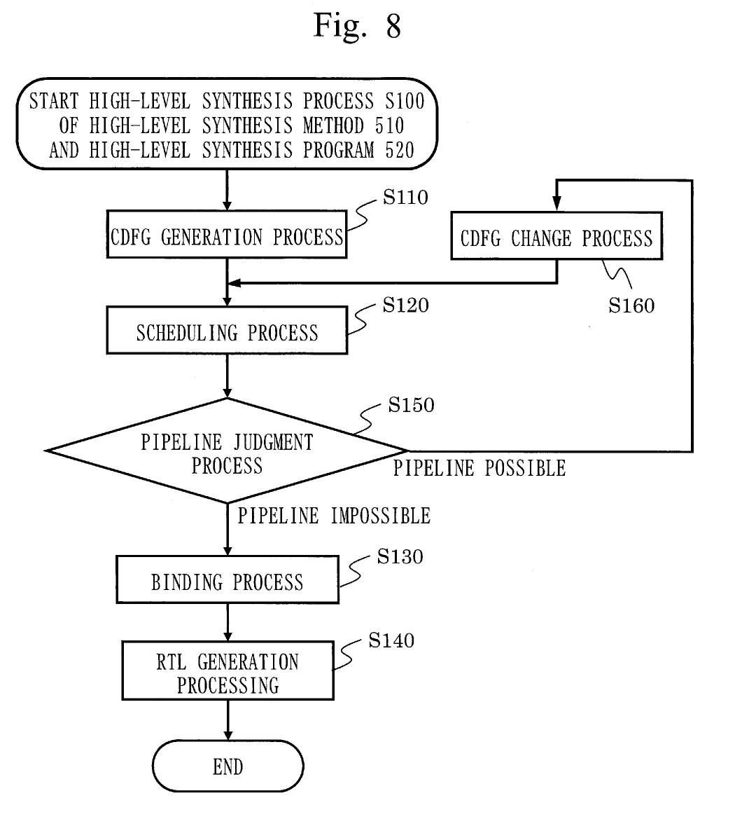

The processing of the high-level synthesis process S100 by a high-level synthesis method 510 and the high-level synthesis program 520 of the high-level synthesis device 100 according to the present embodiment will be schematically described using FIG. 8.

In the high-level synthesis process S100 illustrated in FIG. 8, a pipeline judgment process S150 and a CDFG change process S160 are added to the high-level synthesis process S100x illustrated in FIG. 3. Further, a scheduling process S120 is a process wherein processing to output a scheduling result 122 is added to the scheduling process S120x described in FIG. 3. The processing of the CDFG generation process S110, the binding process S130 and the RTL generation process S140 is the same as that described in FIG. 3.

In the following, the source code 171 describes a behavior of a repeat arithmetic process to repeat an arithmetic process, wherein output of the arithmetic process is used as input to the next arithmetic process.

Further, the first CDFG 111 is a CDFG representing a repeat arithmetic process to repeat an arithmetic process, wherein output of the arithmetic process is used as input to the next arithmetic process. Specifically, the first CDFG 111 is generated from the source code 171 by the CDFG generation unit 110.

Further, in the following, pipelining of the first CDFG 111 means making it possible to perform the repeat arithmetic process represented by the first CDFG 111 through pipeline processing.

In the scheduling process S120, processing to output a scheduling result 122 is added to the scheduling process S120x.

In the scheduling process S120, the scheduling unit 120 outputs a scheduling result 122 in a case wherein the repeat arithmetic process represented by the first CDFG is performed through pipeline processing. Specifically, the scheduling unit 120 outputs information indicating that processing cannot be realized in a control cycle of performing pipeline processing, a data hazard variable for which a data hazard occurs, and the scheduling result 122 including that processing cycles of a pipeline is four cycles. The data hazard variable is a variable for which a data hazard occurs in a case wherein the repeat arithmetic process represented by the first CDFG 111 is performed through pipeline processing. The processing cycles of the pipeline is processing cycles of the arithmetic process.

In the pipeline judgment process S150, the pipeline judgment unit 150 judges whether the repeat arithmetic process represented by the first CDFG 111 can be performed through pipeline processing based on the scheduling result 122. The pipeline judgment unit 150 judges whether the repeat arithmetic process represented by the first CDFG 111 can be performed through pipeline processing based on the data hazard variable included in the scheduling result 122. That is, the pipeline judgment unit 150 judges whether pipelining of the repeat arithmetic process is possible by changing the first CDFG 111. The pipeline judgment unit 150 judges whether pipelining of the first CDFG 111 is possible based on the scheduling result 122 output from the scheduling process S120.

When it is judged that pipelining of the first CDFG 111 is possible, the processing proceeds to the CDFG change process S160.

When it is judged that pipelining of the first CDFG 111 is impossible, the processing proceeds to the binding process S130.

The pipeline judgment process S150 will be described below in detail.

In the CDFG change process S160, the CDFG change unit 160 changes the first CDFG 111, and generates a second CDFG 112 after change. The CDFG change unit 160 obtains the first CDFG 111 representing the repeat arithmetic process, and changes the repeat arithmetic process represented by the first CDFG 111 to the second CDFG 112 to be performed through pipeline processing. The CDFG change unit 160 inputs the second CDFG 112 changed to the scheduling process S120.

The CDFG change process S160 will be described below in detail.

Next, the high-level synthesis process S100 according to the present embodiment will be described further in detail.

<CDFG Generation Process S110>

The CDFG generation process S110 is processing to generate the first CDFG 111 from the source code 171, as mentioned above.

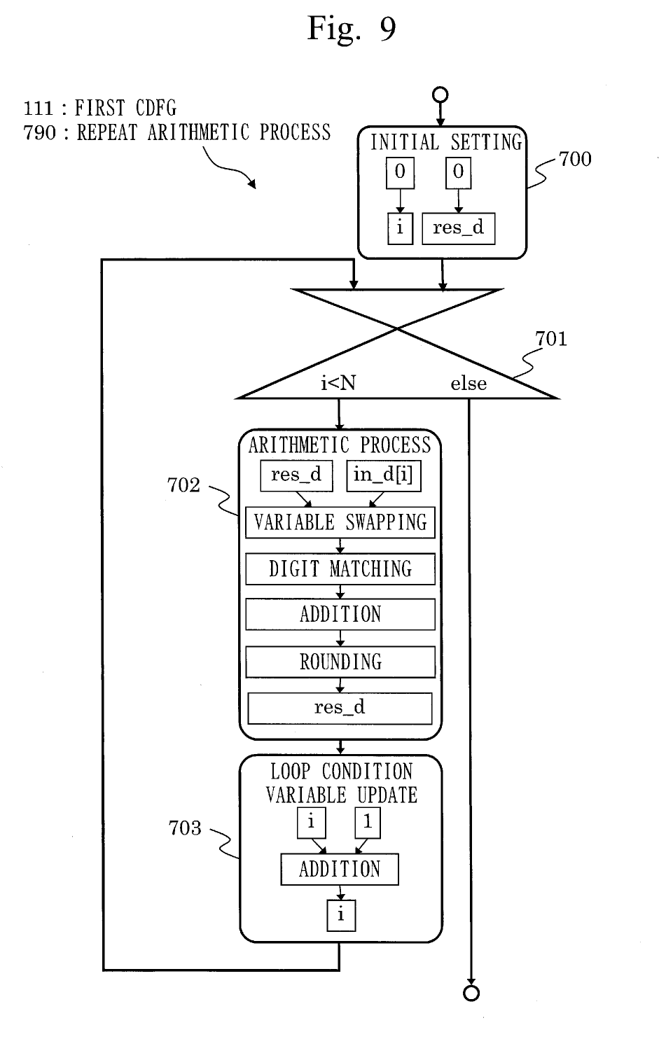

FIG. 9 is a diagram illustrating an example of the first CDFG 111 generated from the source code 171 illustrated in FIG. 4 by the CDFG generation unit 110 according to the present embodiment.

In FIG. 9, the first CDFG 111 represents a repeat arithmetic process 790 to repeat an arithmetic process 702, wherein output of the arithmetic process 702 is used as input to the next arithmetic process 702. The first CDFG 111 is composed of a plurality of data flow graphs (DFGs). An initial setting DFG 700 is an initial setting of a DFG, wherein 0 is set to a variable ‘i’ to judge a loop condition, and 0 is set to an operation result value “res_d.”

A condition judgment DFG 701 represents control of condition judgment, which indicates performing an arithmetic process in a case of “i<N,” and completing an arithmetic process in a case of “else” (other).

The arithmetic process DFG 702 is a DFG of an arithmetic process, which performs an addition process of floating points illustrated in FIG. 5.

Condition update DFG 703 is a DFG to update a variable ‘i’ to perform loop condition judgment, wherein ‘i’ is increased one by one for every one loop.

<Scheduling Process S120>

In the scheduling process S120, the scheduling unit 120 determines a control cycle necessary for performing processing indicated in each node inside the first CDFG 111.

When the first CDFG 111 in FIG. 9 is input, the scheduling unit 120 associates the first CDFG 111 with the processing illustrated in FIG. 5, and assigns one cycle of processing cycles to each of the variable swapping process 302, the digit matching process 303, the addition process 304 and the rounding process 305.

As mentioned above, the scheduling unit 120 tries the control cycle wherein the repeat arithmetic process 790 included in the first CDFG 111 is pipelined. Specifically, the scheduling unit 120 tries the control cycle wherein pipeline processing is performed at the timing illustrated in FIG. 6.

When the processing cannot be performed in the control cycle tried, the scheduling unit 120 tries another method, and determines a control cycle. Specifically, in a case of the pipeline processing illustrated in FIG. 6, the processing cannot be performed since there is a variable having dependency between iterations, and a data hazard occurs. Therefore, the scheduling unit 120 determines a control cycle wherein processing is performed at the timing illustrated in FIG. 7.

The scheduling unit 120 outputs control cycle information 121 as a scheduling result. Specifically, when it is determined the control cycle wherein the processing is performed at the timing illustrated in FIG. 7, the scheduling unit 120 outputs control cycle information 121 including that the control cycle is N*4.

Further, the scheduling unit 120 outputs information indicating that the processing cannot be performed in the control cycle tried as a scheduling result 122. Specifically, the scheduling unit 120 outputs the scheduling result 122 including that the processing cannot be realized in the control cycle to perform pipeline processing, a data hazard variable for which a data hazard occurs, and a processing cycle of a pipeline.

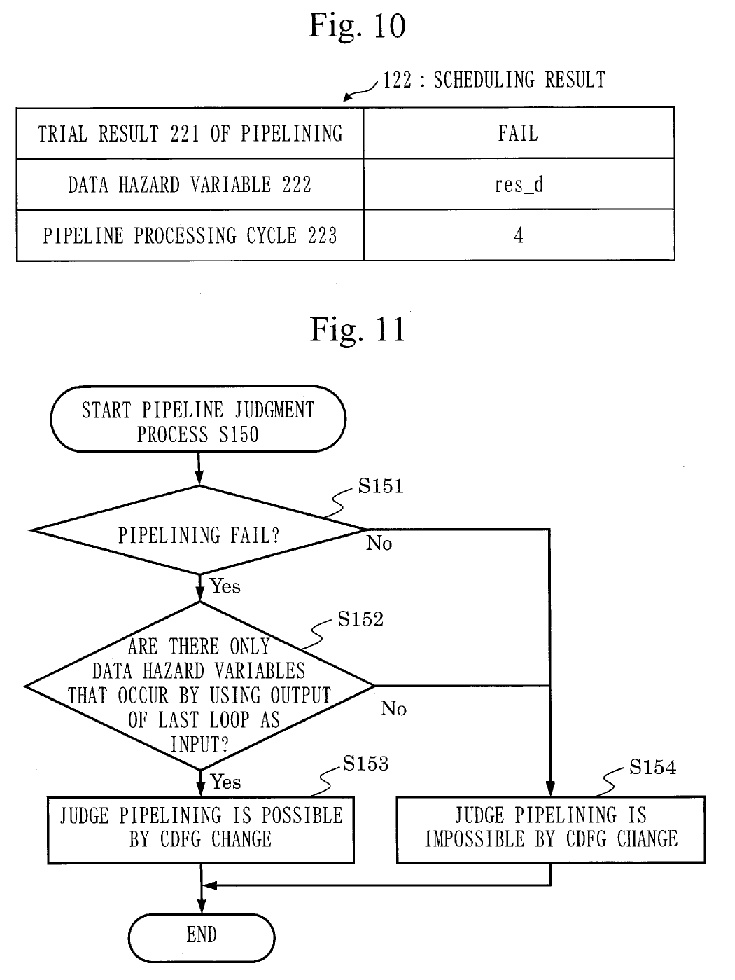

FIG. 10 is a diagram illustrating an example of the scheduling result 122 according to the present embodiment.

When the control cycle of the pipeline processing illustrated in FIG. 6 cannot be performed, the scheduling unit 120 outputs the scheduling result 122 as illustrated in FIG. 10. The scheduling result 122 includes information indicating whether processing can be realized in a control cycle to perform pipeline processing, a data hazard variable 222 for which a data hazard occurs, and a processing cycle of a pipeline. When the control cycle of the pipeline processing illustrated in FIG. 6 cannot be performed, in the scheduling result 122, “fail”0 is set as a pipeline trial result 221, “res_d” is set as a data hazard variable 222, and “4” is set as a processing cycle 223 of the pipeline.

<Pipeline Judgment Process S150>

In the pipeline judgment process S150, the pipeline judgment unit 150 judges whether pipelining of the first CDFG 111 is possible based on the scheduling result 122 notified from the scheduling unit 120. When it is judged that pipelining of the first CDFG 111 is unnecessary or impossible, the pipeline judgment unit 150 outputs the control cycle information 121 output by the scheduling unit 120 to the binding unit 130. When it is judged that pipelining is possible, the pipeline judgment unit 150 notifies the CDFG change unit 160 of the scheduling result 122 notified from the scheduling unit 120, and orders change of the first CDFG 111.

FIG. 11 is a flowchart of the pipeline judgment process S150 according to the present embodiment.

In a step S151, the pipeline judgment unit 150 judges whether a data hazard occurs and pipelining fails based on the scheduling result 122. Specifically, the pipeline judgment unit 150 judges whether a data hazard occurs and pipelining fails from a “trial result of pipelining” column and a “data hazard variable” column in the scheduling result 122. In the example of FIG. 10, the pipeline judgment unit 150 judges that a data hazard occurs and pipelining fails, since the “trial result of pipelining” column is “fail” and “res_d” is set in the “data hazard variable” column. When the pipeline judgment unit 150 judges that a data hazard occurs and pipelining fails, the procedure proceeds to a step S152, and in other cases, the procedure proceeds to a step S154.

In the step S152, based on the scheduling result 122, the pipeline judgment unit 150 judges whether there are only data hazard variables that occur by using output variables of the last arithmetic process (i.e., last loop) as input variables for the next arithmetic process. The fact that there are only data hazard variables that occur by using the output variables of the last arithmetic process (i.e., last loop) as the input variables for the next arithmetic process means that a data hazard that depends on an operation order of a plurality of operation nodes included in the arithmetic process does not occur. Specifically, the pipeline judgment unit 150 compares variables set in the “data hazard variable” column in the scheduling result 122 with the first CDFG 111, and judges whether the variables set in the “data hazard variable” column in the scheduling result 122 are used only for the output variables of the last arithmetic process and for the input variables of the next arithmetic process. When the pipeline judgment unit 150 detects that a data hazard that occurs in pipeline processing occurs by inputting the output variables in the last loop, and that a data hazard depending on the operation order of the operation nodes does not occur, the procedure proceeds to a step S153. In the other cases, the procedure proceeds to the step S154.

In the step S153, the pipeline judgment unit 150 judges that pipelining of the first CDFG is possible. When it is judged that pipelining is possible, the pipeline judgment unit 150 notifies the CDFG change unit 160 of the scheduling result 122 notified from the scheduling unit 120, and orders change of the first CDFG 111.

In the step S154, the pipeline judgment unit 150 judges that pipelining of the first CDFG 111 is unnecessary or impossible. When it is judged that pipelining is unnecessary or impossible, the pipeline judgment unit 150 outputs the control cycle information 121 output from the scheduling unit 120 to the binding unit 130.

<CDFG Change Process S160>

In the CDFG change process S160, the CDFG change unit 160 changes the first CDFG 111 to the second CDFG 112 wherein the repeat arithmetic process 790 represented by the first CDFG 111 is performed through pipeline processing. When it is judged that the repeat arithmetic process 790 represented by the first CDFG 111 can be performed through pipeline processing by the pipeline judgment unit 150, the CDFG change unit 160 changes the first CDFG 111 to the second CDFG 112.

In other words, the CDFG change unit 160 changes the first CDFG 111 generated by the CDFG generation unit 110 so as to be realized through pipeline processing of processing cycles of an arithmetic process (loop processing). That is, the CDFG change unit 160 changes the first CDFG 111 to the second CDFG 112 so that the first CDFG 111 can be realized through the pipeline processing of four cycles being the processing cycle of the arithmetic process (loop processing).

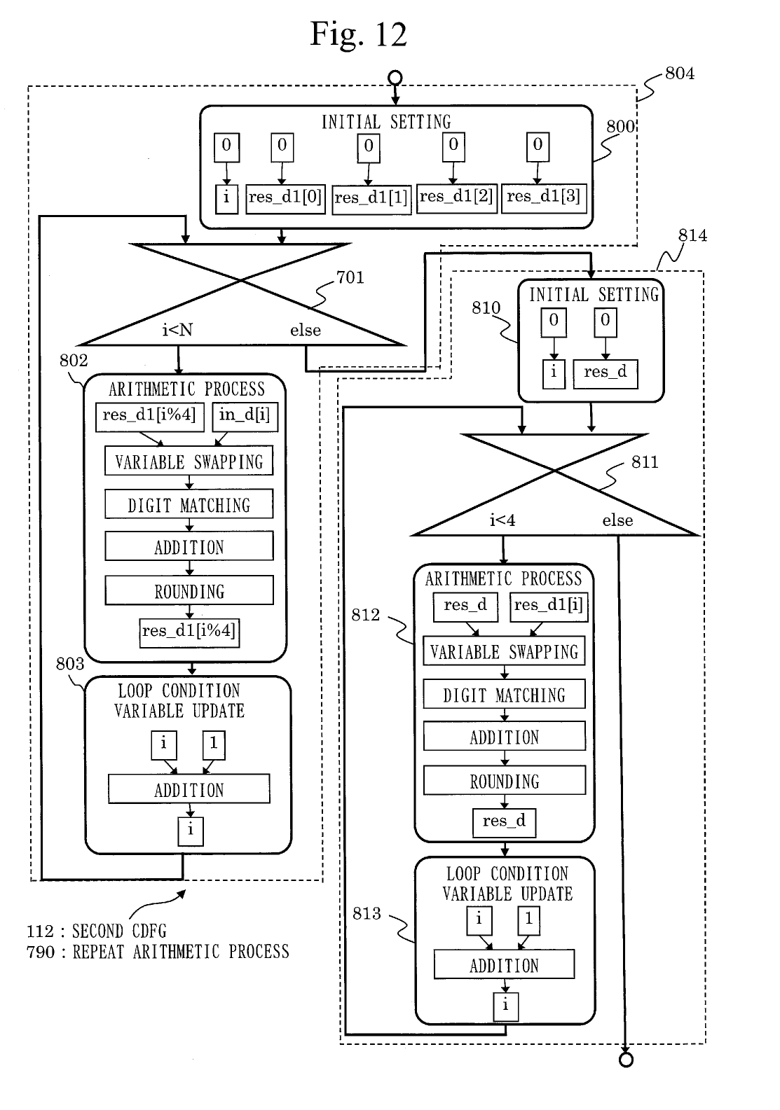

FIG. 12 is a diagram illustrating one example of the second CDFG 112 whereto the first CDFG 111 is changed by the CDFG change unit 160 according to the present embodiment.

The CDFG change unit 160 changes the first CDFG 111 to the second CDFG 112 based on the loop count of the repeat arithmetic process 790, and the processing cycles of the arithmetic process.

The CDFG change unit 160 divides, in the first CDFG 111, the repeat arithmetic process 790 into repeat arithmetic sub-processes of the number of the processing cycles. Then, the CDFG change unit 160 changes the repeat arithmetic sub-processes into the second CDFG 112 representing the first arithmetic process 804 to perform repeat arithmetic sub-processes of the number of the processing cycles, and the second arithmetic process 814 to perform an arithmetic process 812 by using each output of the repeat arithmetic sub-processes of the number of the processing cycles as input.

The first arithmetic process 804 can be performed through pipeline processing. The first arithmetic process 804 is also called the first repeat arithmetic process. The second arithmetic process 814 can be performed through pipeline processing. Here, the second arithmetic process 814 can be also performed through time-division processing. The second arithmetic process 814 is also called the second repeat arithmetic process.

FIG. 12 indicates the second CDFG 112 whereto the first CDFG 111 illustrated in FIG. 9 is changed so as to be realized through pipeline processing of four cycles being processing cycles of an arithmetic process (loop processing). In FIG. 12, the same configuration is denoted by the same sign.

In the second CDFG 112 in FIG. 12, the points different from those in the first CDFG 111 illustrated in FIG. 9 are as follows.

The first point is that the initial setting 700 of the first CDFG 111 is changed to an initial setting 800 in the second CDFG 112.

The second point is that the arithmetic process 702 of the first CDFG 111 is changed to an arithmetic process 802 in the second CDFG 112.

The third point is that the second arithmetic process composed of an initial setting 810, a condition judgment 811, an arithmetic process 712 and a loop condition variable update 813 is added in the second CDFG 112.

In the second CDFG 112 of FIG. 12, the first arithmetic process 804 is performed by the initial setting 800, the condition judgment 701, the arithmetic process 802 and the loop condition variable update 803, and “res_d1[0]” through “res_d1[3]” are calculated from input variables “in_d[0]” through “in_d[N−1].” Further, in the second CDFG 112, the second arithmetic process 814 is performed by the initial setting 810, the condition judgment 811, the arithmetic process 812 and the loop condition variable update 813. In the second CDFG 112, by using “res_d1[0] through “res_d1[3]” being output of the first CDFG 111 as input, “res_d1[0]+res_d1[1]+res_d1[2]+res_d1[3]” is performed to be calculated as “res_d”.

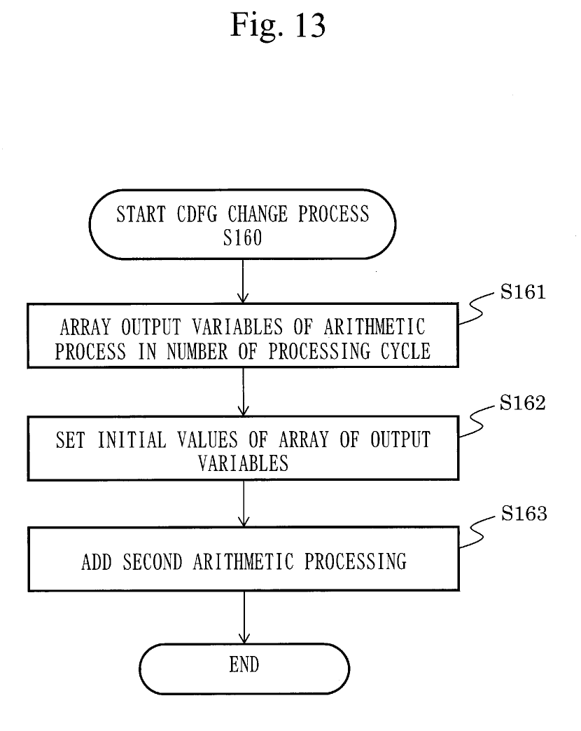

FIG. 13 is a flowchart of the CDFG change process S160 according to the present embodiment.

In a step S161, the CDFG change unit 160 changes the first CDFG 111 so that output variables “res_d” of the arithmetic process 702 are arrayed in the number of processing cycles of the arithmetic process (pipeline processing). In the present embodiment, since the cycle number of the arithmetic process (pipeline processing) is four, the CDFG change unit 160 arrays output variables in “res_d1[0] through res_d1[4]” as in the arithmetic process 802, and assigns an acquisition source and a save destination of the operation result as “red_d1[i%4], from “res_d1[0]” through “res_d1[3]” for each loop count.

In a step S162, the CDFG change unit 160 changes the first CDFG 111 so as to set initial values of the output variables arrayed. The CDFG change unit 160 changes the first CDFG 111 so as to set the initial values of the output variables “res_d1[0] through res_d1[4]” arrayed. Specifically, the CDFG change unit 160 adds output variables “res_d[]=0,” “res_d[1]=0,” “res_d[2]=0” and “res_d[3]=0” to the first CDFG 111, as in the initial setting 800.

In a step S163, the CDFG change unit 160 adds the second arithmetic process 814. The CDFG of the second arithmetic process 814 to be added is the same as the first CDFG 111 before change. The second arithmetic process 814 is different in that input variables of the arithmetic process are output of the first arithmetic process 804, and that the number of times of repeat operation of the arithmetic process 812 is the cycle number of the arithmetic process (pipeline processing).

Specifically, the CDFG change unit 160 first reproduces the initial setting 700 and generates an initial setting 800. Next, the CDFG change unit 160 changes the number of repeat operation “i<N” of the condition judgment 701 to “i<4”, and generates a condition judgment 811. Next, the CDFG change unit 160 changes the input variables “in_d” of the arithmetic process 702 to “red_{d1}[i]”, and generates an arithmetic process 812. Lastly, the CDFG change unit 160 reproduces the loop condition variable update 703, and generates a loop condition variable update 813.

As described above, the CDFG change unit 160 divides the repeat arithmetic process 790 into four repeat arithmetic sub-processes, being the number of processing cycles, by arraying the output variables of the arithmetic process in the number of processing cycles. Four repeat arithmetic sub-processes are each arithmetic process 802 to input “red_d1[i%4]” and “in_d[i]” and output “red_d1[i%4]”. Four repeat arithmetic sub-processes can be performed through pipeline processing. Then, the CDFG change unit 160 outputs each execution result of four repeat arithmetic sub-processes to the second arithmetic process 814, and performs an arithmetic process 812.

This concludes the explanation of the high-level synthesis process S100 according to the present embodiment.

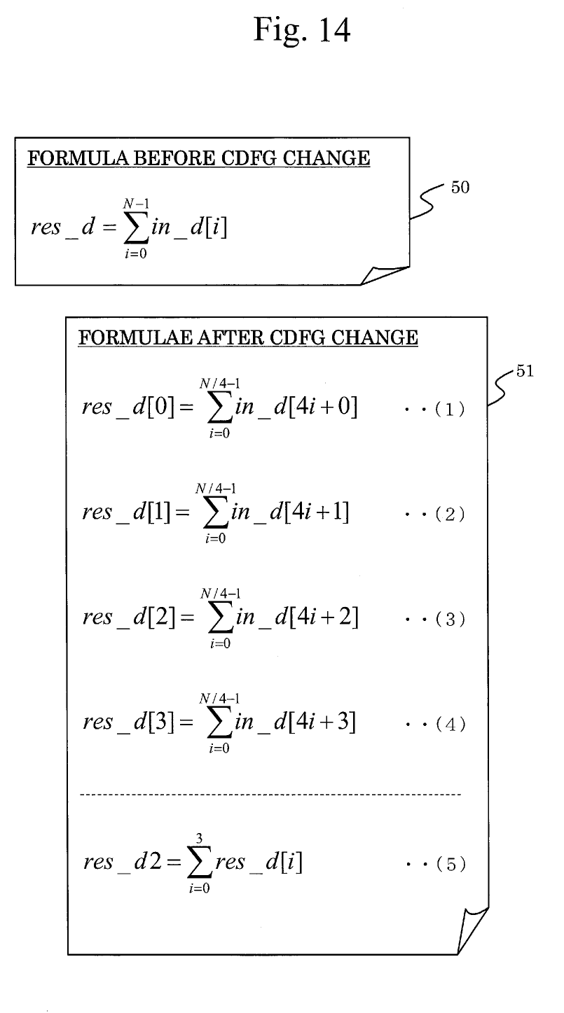

FIG. 14 is an example representing an arithmetic process before and after the CDFG change process S160 according to the present embodiment in mathematical formulae.

A formula 50 represents the first CDFG 111 illustrated in FIG. 9 before the CDFG change process S160. (1) through (5) of formulae 51 represent the second CDFG 112 illustrated in FIG. 12 after the CDFG change process S160. (1) through (4) of the formulae 51 correspond to the first arithmetic process 804, and (5) of the formulae 51 corresponds to the second arithmetic process 814.

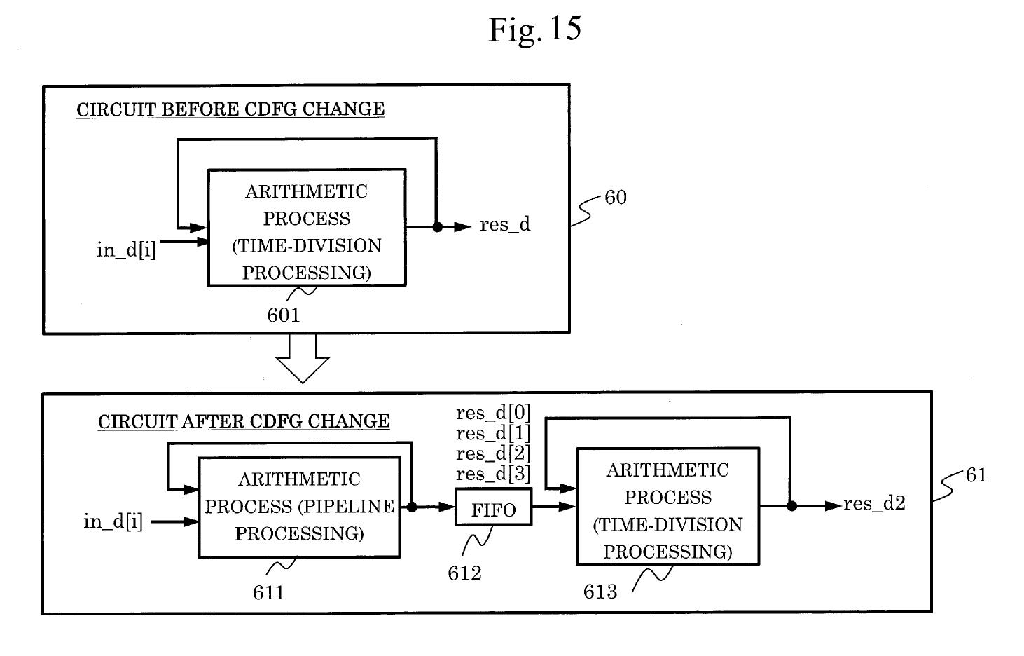

FIG. 15 is an example representing an arithmetic process before and after the CDFG change process S160 according to the present embodiment by circuits.

A circuit diagram 60 represents a circuit generated from the first CDFG 111 illustrated in FIG. 9 before the CDFG change process S160. A circuit diagram 61 represents a circuit generated from the second CDFG 112 illustrated in FIG. 12 after the CDFG change process S160.

In the circuit diagram 60, since the arithmetic processing circuit 601 cannot be performed through pipeline processing, the arithmetic processing circuit 601 is performed through time-division processing.

Meanwhile, in the circuit diagram 61, an arithmetic processing circuit 611 corresponds to the first arithmetic process 804 in FIG. 12, and an arithmetic processing circuit 613 corresponds to the second arithmetic process 814 in FIG. 12. The arithmetic processing circuit 611 performs an arithmetic process through pipeline processing, and after the operation result is once stored in an FIFO 612, performs an arithmetic process by the arithmetic processing circuit 613 through time-division processing.

### Other Configuration

In FIG. 15 of the present embodiment, the example is illustrated wherein the arithmetic processing circuit 613 corresponding to the second arithmetic process 814 is performed through time-division processing; however, the second arithmetic process may be performed through pipeline processing similarly as the first arithmetic process, and may be performed through parallel processing.

Further, in the present embodiment, the example is provided of the case wherein the cycle number of the pipeline processing is four; however, the present embodiment can be also applied to a case wherein the cycle number of pipeline processing is other than four. The CDFG may be changed in such a way that in the first arithmetic process, the operation result is stored in arrays of the cycle number of the pipeline processing, and in the second arithmetic process, operation is performed by using as input the arrays of the cycle number of the pipeline processing.

Further, in the present embodiment, the example is provided wherein addition of floating points is taken as an example of an arithmetic process; however, the arithmetic process as a target of the present embodiment is not limited to addition of floating points. In the first arithmetic process 804 in FIG. 12, the arithmetic process itself is the same as that of the repeat arithmetic process 790 in FIG. 9, but only the number of arrays of input and output values is different. Further, in the second arithmetic process 814 of FIG. 12, the arithmetic process is the same as that in the repeat arithmetic process 790 in FIG. 9, but only the storage destination of the input and output values is different. Thus, it is possible to apply to the present embodiment behavioral descriptions if only the behavioral descriptions repeatedly perform an arithmetic process by using input variables and output variables of the arithmetic process as input, without limiting the contents of the arithmetic process.

Further, the high-level synthesis device 100 may include a communication device, and receive the source code 171, the synthesis restriction information 172 and the circuit information 173 via the communication device. Further, the high-level synthesis device 100 may transmit the RTL 174 via the communication device. In this case, the communication device includes a receiver and a transmitter. Specifically, the communication device is a communication chip or a network interface card (NIC). The communication device functions as a communication unit to communicate data. The receiver functions as a receiving unit to receive data, and the transmitter functions as a transmitting unit to transmit data.

Further, in the present embodiment, the functions of the “units” of the high-level synthesis device 100 are realized by software; however, as a variation, the functions of the “units” of the high-level synthesis device 100 may be realized by hardware components.

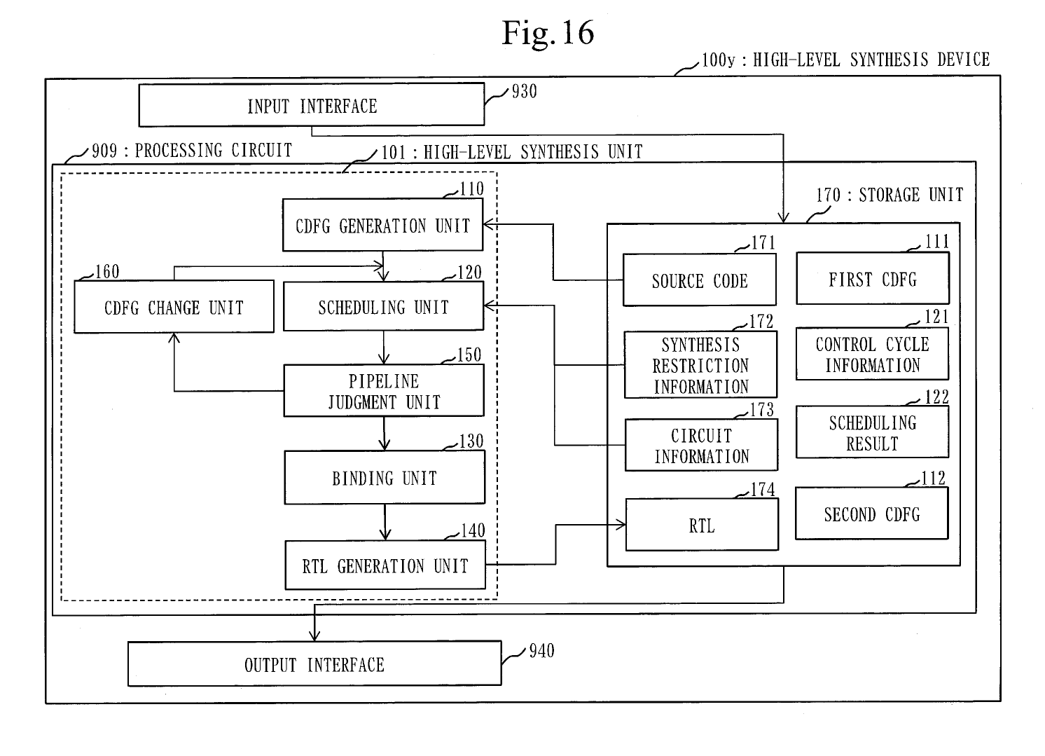

A configuration of a high-level synthesis device 100y according to a variation of the present embodiment will be described using FIG. 16. As illustrated in FIG. 16, the high-level synthesis device 100y is equipped with hardware components such as a processing circuit 909, an input interface 930 and an output interface 940.

The processing circuit 909 is a dedicated electronic circuit for realizing the functions of the “units” described above and the storage unit 170. The processing circuit 909 is specifically a single circuit, a composite circuit, a processor that has been made into a program, a processor that has been made into a parallel program, a logic IC, a gate array (GA), an application specific integrated circuit (ASIC) or a field-programmable gate array (FPGA).

The functions of the “units” may be realized by one processing circuit 909 or may be realized dispersedly by a plurality of processing circuits 909.

As another variation, the functions of the high-level synthesis device 100 may be realized by combination of software and hardware. That is, a part of the functions of the high-level synthesis device 100 may be realized by dedicated hardware, and the rest of the functions may be realized by software.

The processor 910, the storage device 920 and the processing circuit 909 are collectively referred to as “processing circuitry.” That is, the functions of the “units” and the storage unit 170 are realized by the processing circuitry even when the configuration of the high-level synthesis device 100 is any of the configurations as illustrated in FIG. 1 and FIG. 16.

The “units” may be replaced with “steps,” “procedures” or “processing.” Further, the functions of the “units” may be realized by firmware.

### Explanation of Effects of Present Embodiment

As described above, the high-level synthesis device 100 according to the present embodiment includes the CDFG change unit to change CDFGs. The CDFG change unit changes CDFGs in such a manner that it is possible to perform a repeat arithmetic process to repeat an arithmetic process, using output variables as the next input variables, through pipeline processing. Thus, it is possible to make the repeat arithmetic process to repeat the arithmetic process using output variables as the next input variables be also pipelined, and to obtain an appropriate operation result. Further, it is possible to generate an RTL description with high processing performance (product of processing latency and a clock cycle) also in a circuit wherein a result of the last time is referred to for input to processing in one loop as described above.

Further, the high-level synthesis device 100 according to the present embodiment includes the pipeline judgment unit to judge whether a repeat arithmetic process can be performed through pipeline processing based on a scheduling result notified from the scheduling unit. Since it is possible for the CDFG change unit to change a CDFG only when pipeline processing is possible by the pipeline judgment unit, it is possible to efficiently change the CDFG while omitting unnecessary processing.

Further, since the high-level synthesis device 100 according to the present embodiment determines a change method of a CDFG according to the cycle number of pipeline processing, the CDFG can be changed using the original CDFG.

In the above, the embodiment of the present invention is described; however, any one or any arbitrary combination of what are described as the “units” in the explanation of the embodiment may be adopted. That is, functional blocks of the high-level synthesis device are arbitrary as long as the functional blocks can realize the functions as described in the above embodiment. The high-level synthesis device may be configured by any combination of or arbitrary block configuration of those functional blocks. Further, the high-level synthesis device needs not be one device, but may be a high-level synthesis system configured by a plurality of devices.

Further, a plurality of parts of the embodiment may be combined and implemented. Otherwise, the embodiment may be partially implemented. Additionally, the embodiment may be partially or as a whole implemented in any combined manner.

Note that the embodiment as mentioned above is essentially preferable examples, not aiming at limiting the range of the present invention, application and use thereof, and various alterations can be made as needed.

### REFERENCE SIGNS LIST

50, 51: formula; 60, 61: circuit diagram; 100, 100x, 100y: high-level synthesis device; 101, 101x: high-level synthesis unit; 110: CDFG generation unit; 111: CDFG; 120, 120x: scheduling unit; 121: control cycle information; 122: scheduling result; 130: binding unit; 140: RTL generation unit; 150: pipeline judgment unit; 160: CDFG change unit; 112: second CDFG; 170: storage unit; 171: source code; 172: synthesis restriction information; 173: circuit information; 174: RTL; 221: trial result; 222: data hazard variable; 223: processing cycle; 300: input variable A; 301: input variable B; 302: variable swapping process; 303: digit matching process; 304: addition process; 305:

rounding process; 306: operation result; 310: comparison; 311: switch; 312: subtraction; 313: shifter; 400, 500: loop; 401, 501: cycle; 403, 403, 502, 503: processing; 510: high-level synthesis method; 520: high-level synthesis program; 601, 611, 613: arithmetic processing circuit; 700, 800, 810: initial setting; 701, 811: condition judgment; 702, 802, 812: arithmetic process; 703, 803, 813: loop condition variable update; 790: repeat arithmetic process; 804: first arithmetic process; 814: second arithmetic process; 909: processing circuit; 910: processor; 920: storage device; 921: memory; 922: auxiliary storage device; 930: input interface; 940: output interface; S100, S100x: high-level synthesis process; S110: CDFG generation process; S120, S120x: scheduling process; S130: binding process; S140: RTL generation process; S150:

pipeline judgment process; S160: CDFG change process

1.-9. (canceled)

10. A high-level synthesis device comprising:
processing circuitry
to obtain, as a first CDFG, a CDFG representing a repeat arithmetic process to repeat an arithmetic process, the repeat arithmetic process using an output of the arithmetic process as an input to a next arithmetic process, and
to change the first CDFG into a second CDFG to perform the repeat arithmetic process represented by the first CDFG through pipeline processing.

11. The high-level synthesis device as defined in claim 10, wherein the processing circuitry
outputs a scheduling result in a case wherein the repeat arithmetic process represented by the first CDFG is performed through the pipeline processing,
judges, based on the scheduling result, whether the repeat arithmetic process represented by the first CDFG can be performed through the pipeline processing, and
changes the first CDFG into the second CDFG in a case wherein it is judged that the repeat arithmetic process represented by the first CDFG can be performed through the pipeline processing.

12. The high-level synthesis device as defined in claim 11, wherein the processing circuitry
outputs the scheduling result including, as a data hazard variable, a variable for which a data hazard occurs in a case wherein the repeat arithmetic process represented by the first CDFG is performed through the pipeline processing, and
judges whether the repeat arithmetic process represented by the first CDFG can be performed through the pipeline processing, based on the data hazard variable included in the scheduling result.

13. The high-level synthesis device as defined in claim 10, wherein
the processing circuitry changes the first CDFG into the second CDFG based on a loop count of the repeat arithmetic process and a processing cycle of the arithmetic process.

14. The high-level synthesis device as defined in claim 13, wherein
the processing circuitry divides the repeat arithmetic process into a repeat arithmetic sub-process of the number of the processing cycle, and changes the first CDFG into the second CDFG representing a first arithmetic process to perform the repeat arithmetic sub-process of the number of the processing cycle, and a second arithmetic process to perform the arithmetic process using each output of the repeat arithmetic sub-process of the number of the processing cycle as an input.

15. The high-level synthesis device as defined in claim 14, wherein the first arithmetic process can be performed through the pipeline processing.

16. The high-level synthesis device as defined in claim 14, wherein the second arithmetic process can be performed through the pipeline processing.

17. A high-level synthesis method of a high-level synthesis device, the method comprising:
obtaining, as a first CDFG, a CDFG to represent a repeat arithmetic process to repeat an arithmetic process, the repeat arithmetic process using an output of the arithmetic process as an input to a next arithmetic process, and changing the first CDFG into a second CDFG to perform the repeat arithmetic process represented by the first CDFG through pipeline processing.

18. A non-transitory computer readable recording medium storing a high-level synthesis program to make a computer execute a control data flow graph (CDFG) change process to obtain, as a first CDFG, a CDFG to represent a repeat arithmetic process to repeat an arithmetic process, the repeat arithmetic process using an output of the arithmetic process as an input to a next arithmetic process, and to change the first CDFG into a second CDFG to perform the repeat arithmetic process represented by the CDFG through pipeline processing.

19. The high-level synthesis device as defined in claim 11, wherein
the processing circuitry changes the first CDFG into the second CDFG based on a loop count of the repeat arithmetic process and a processing cycle of the arithmetic process.

20. The high-level synthesis device as defined in claim 12, wherein
the processing circuitry changes the first CDFG into the second CDFG based on a loop count of the repeat arithmetic process and a processing cycle of the arithmetic process.

21. The high-level synthesis device as defined in claim 19, wherein
the processing circuitry
divides the repeat arithmetic process into a repeat arithmetic sub-process of the number of the processing cycle, and
changes the first CDFG into the second CDFG representing a first arithmetic process to perform the repeat arithmetic sub-process of the number of the processing cycle, and a second arithmetic process to perform the arithmetic process using each output of the repeat arithmetic sub-process of the number of the processing cycle as an input.

22. The high-level synthesis device as defined in claim 20, wherein
the processing circuitry
divides the repeat arithmetic process into a repeat arithmetic sub-process of the number of the processing cycle, and
changes the first CDFG into the second CDFG representing a first arithmetic process to perform the repeat arithmetic sub-process of the number of the processing cycle, and a second arithmetic process to perform the arithmetic process using each output of the repeat arithmetic sub-process of the number of the processing cycle as an input.

23. The high-level synthesis device as defined in claim 21, wherein the first arithmetic process can be performed through the pipeline processing.

24. The high-level synthesis device as defined in claim 22, wherein the first arithmetic process can be performed through the pipeline processing.

25. The high-level synthesis device as defined in claim 21, wherein the second arithmetic process can be performed through the pipeline processing.

26. The high-level synthesis device as defined in claim 22, wherein the second arithmetic process can be performed through the pipeline processing.

27. The high-level synthesis device as defined in claim 23, wherein the second arithmetic process can be performed through the pipeline processing.

28. The high-level synthesis device as defined in claim 24, wherein the second arithmetic process can be performed through the pipeline processing.

29. The high-level synthesis device as defined in claim 14, wherein the second arithmetic process can be performed through the pipeline processing.
